(19) United States
(12) Patent Application Publication
(10) Pub. No.: US 2025/0192134 A1
(43) Pub. Date: Jun. 12, 2025

(54) BATTERY

(71) Applicant: TOYOTA JIDOSHA KABUSHIKI KAISHA, Toyota-shi (JP)

(72) Inventor: Takuya SUGIMOTO, Toyota-shi (JP)

(73) Assignee: TOYOTA JIDOSHA KABUSHIKI KAISHA, Toyota-shi (JP)

(21) Appl. No.: 18/928,407

(22) Filed: Oct. 28, 2024

(30) Foreign Application Priority Data
Dec. 6, 2023 (JP) 2023-206481

(51) Int. Cl. H01M 4/04; H01M 4/02; H01M 4/66; H01M 10/0525

(52) U.S. Cl. CPC H01M 4/0404; H01M 4/661; H01M 10/0525; H01M 2004/027; H01M 2004/028

(57) ABSTRACT

A current collector, a plurality of electrodes having at least one of a positive electrode active material layer and a negative electrode active material layer formed on the current collector, and a laminate formed by laminating a plurality of separators located between the positive electrode active material layer and the negative electrode active material layer in a predetermined lamination direction, a part of the current collector is a current collector foil in which the positive electrode active material layer and the negative electrode active material layer are not formed, and when the laminate is viewed along the lamination direction, an outer peripheral side end portion of the current collector foil located at a central portion in the lamination direction is located on an outer peripheral side from an outer peripheral side end portion of the current collector foil located at an end portion in the lamination direction.

### CROSS-REFERENCE TO RELATED APPLICATION

This application claims priority to Japanese Patent Application No. 2023-206481 filed on Dec. 6, 2023, incorporated herein by reference in its entirety.

### BACKGROUND

### 1. Technical Field

The present disclosure relates to a battery.

### 2. Description of Related Art

Japanese Unexamined Patent Application Publication No. 2017-168266 (JP 2017-168266 A) below discloses a battery formed by laminating a plurality of electrodes including bipolar electrodes in a predetermined lamination direction.

### SUMMARY

When the battery in JP 2017-168266 A receives a load in a direction orthogonal to the lamination direction from a conductive member, there is a possibility that an external short circuit with large heat may occur between current collector foils of the plurality of current collectors.

In consideration of the above fact, it is an object of the present disclosure to provide a battery in which an external short circuit with large heat hardly occurs between current collector foils of the current collectors when a load is received from a conductive member in a direction orthogonal to the lamination direction of electrodes.

A battery of a first aspect includes a laminate, the laminate being configured by laminating, in a predetermined lamination direction,
current collectors,
a plurality of electrodes each including at least one of a positive electrode active material layer and a negative electrode active material layer formed on each of the current collectors, and
a plurality of separators located between the positive electrode active material layers and the negative electrode active material layers, in which
the current collectors each have a portion made of a current collector foil where the positive electrode active material layer and the negative electrode active material layer are not formed, and
when the laminate is viewed in the lamination direction, outer peripheral end portions of the current collector foils that are located at a central portion in the lamination direction are located on outer peripheral sides of the outer peripheral end portions of the current collector foils that are located at end portions in the lamination direction.

In the battery of the first aspect, when the laminate is viewed in the lamination direction of the laminate, the outer peripheral end portions of the current collector foils that are located at the central portion in the lamination direction are located on the outer peripheral sides of the outer peripheral end portions of the current collector foils that are located at the end portions in the lamination direction. Therefore, when the battery receives a load in a direction orthogonal to the lamination direction from a conductive member, the conductive member is less likely to come into contact with the current collector foils located at the central portion and the current collector foils located at the end portions in the lamination direction at the same time. In other words, in the battery of the first aspect, an external short circuit with large heat hardly occurs between the current collector foils of the plurality of current collectors.

In the battery of a second aspect according to the first aspect, the electrodes other than the electrodes located at the end portions in the lamination direction are bipolar electrodes each including the current collector, the positive electrode active material layer formed on one surface of the current collector, and the negative electrode active material layer formed on another surface of the current collector.

The battery of the second aspect is capable of outputting a larger electric power as compared with the case where the bipolar electrodes are not provided.

In the battery of a third aspect according to the first or second aspect, the outer peripheral end portions of the current collector foil that is located at the center in the lamination direction is located on the outer peripheral sides of the outer peripheral end portions of the current collector foils that are located at the end portions in the lamination direction.

In the battery of the third aspect, the outer peripheral end portions of the current collector foil that is located at the center in the lamination direction is located on the outer peripheral sides of the outer peripheral end portions of the current collector foils that are located at the end portions in the lamination direction. According to the configuration, the conductive member in contact with the current collector foil located at the center hardly comes into contact with the current collector foils located at both the end portions in the lamination direction.

Here, when the total number of the current collectors is an odd number, the “current collector foil located at the center” is the current collector foil of one current collector, and when the total number of the current collectors is an even number, the current collector foils of two current collectors correspond to the “current collector foil located at the center”. Furthermore, in the case where the total number of the current collectors is an even number, the outer peripheral end portions of the current collector foils of the two current collectors may be located on the outer peripheral sides of the outer peripheral end portions of the current collector foils located at the end portions in the lamination direction. Alternatively, only the outer peripheral end portions of one of the two current collectors may be located on the outer peripheral sides of the outer peripheral end portions of the current collector foils located at the end portions in the lamination direction.

In the battery of a fourth aspect according to the first or second aspect, when the laminate is viewed in the lamination direction, a distance between the outer peripheral end portions of the current collector foils adjacent to each other in the lamination direction is larger than a size of the current collectors in the lamination direction.

According to the fourth aspect, when a load is received from the conductive member in a direction orthogonal to the lamination direction, an external short circuit hardly occurs between the current collector foils adjacent to each other in the lamination direction.

In the battery of a fifth aspect according to the first or second aspect, when the current collector, having the outer peripheral end portions that are located on outermost peripheral sides when the laminate is viewed in the lamination direction, is defined as a maximum protruding current collector,
the current collectors, other than the maximum protruding current collector, have the outer peripheral end portions that are located on inner peripheral sides of the outer peripheral end portions of the current collector foils on the current collectors that are located closer to the maximum protruding current collector.

According to the fifth aspect, when a load is received from the conductive member in a direction orthogonal to the lamination direction, an external short circuit hardly occurs between the current collector foils.

As described above, the battery according to the present disclosure has an excellent effect that an external short circuit with large heat hardly occurs between the current collector foils of the plurality of current collectors when a load is received from the conductive member in a direction orthogonal to the lamination direction of the plurality of electrodes.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic perspective view of a bipolar lithium-ion secondary battery according to an embodiment;

FIG. 2 is a schematic cross-sectional view taken along line 2-2 of FIG. 1; and

FIG. 3 is a schematic cross-sectional view of the laminate and the conductive member when an external short circuit occurs due to a collision of the conductive member with the lithium ion secondary battery.

### DETAILED DESCRIPTION OF EMBODIMENTS

Hereinafter, a bipolar lithium ion secondary battery (hereinafter, referred to as a battery 10) according to an embodiment will be described. The battery 10 can be mounted on a variety of devices. The battery 10 of the present embodiment is mounted on a battery electric vehicle (BEV: Battery Electric Vehicle) and is capable of supplying electric power to an electric motor serving as a drive source. The arrow UP, the arrow FR, and the arrow LH shown in the drawings respectively indicate the upper side in the up-down direction, the front side in the front-rear direction, and the left side in the left-right direction.

First, the basic configuration of the battery 10 will be described. The battery 10 of the present embodiment includes a laminate 15 and a resin member 30.

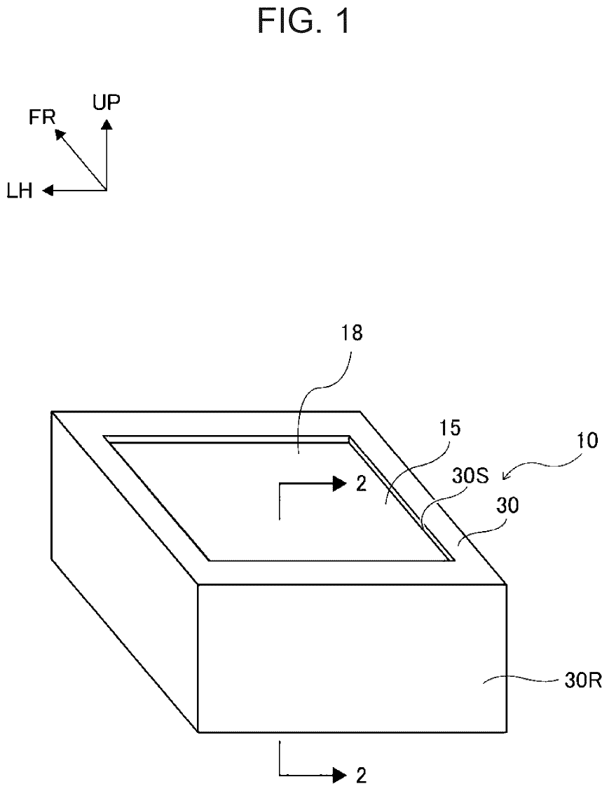

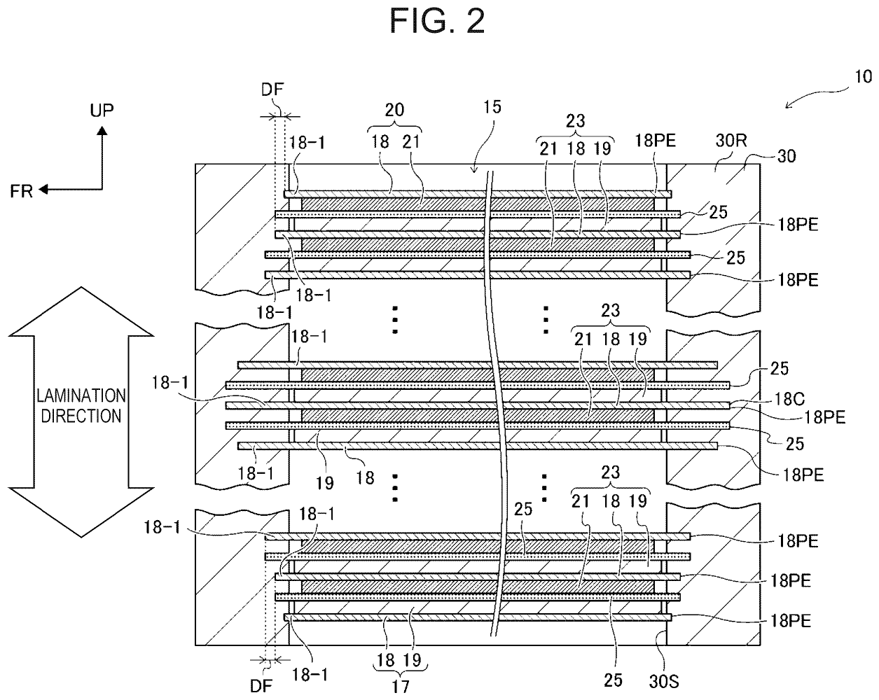

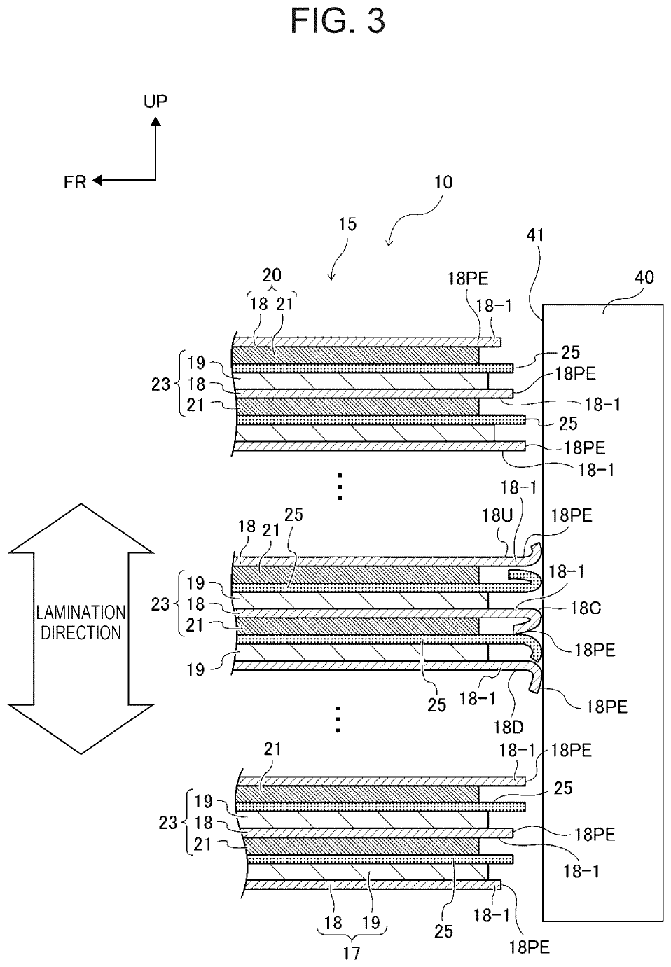

The laminate 15 is formed by stacking a plurality of electrodes and a plurality of separators 25 in a predetermined lamination direction (vertical direction in FIG. 1). As shown in FIG. 2, these electrodes include a negative electrode termination electrode 17, a positive electrode termination electrode 20, and a plurality of bipolar electrodes 23. The laminate 15 of the present embodiment includes 11 electrodes (a negative electrode termination electrode 17, a positive electrode termination electrode 20, and a bipolar electrode 23). That is, the laminate 15 has 11 current collectors 18. Note that some of the bipolar electrodes 23 are not shown in FIGS. 2 and 3.

The negative electrode termination electrode 17 includes a current collector 18 and a negative electrode active material layer 19 provided on one surface (upper surface in FIG. 1) of the current collector 18. The positive electrode termination electrode 20 includes a current collector 18 and a positive electrode active material layer 21 provided on one surface (lower surface in FIG. 1) of the current collector 18. Each bipolar electrode 23 includes a current collector 18, a negative electrode active material layer 19 provided on one surface (upper surface in FIG. 2) of the current collector 18, and a positive electrode active material layer 21 provided on the other surface (lower surface in FIG. 2) of the current collector 18.

A separator 25 is provided between the negative electrode active material layer 19 of the negative electrode termination electrode 17 and the positive electrode active material layer 21 of the bipolar electrode 23 adjacent to the negative electrode termination electrode 17. Furthermore, a separator 25 is provided between the positive electrode active material layer 21 of the positive electrode termination electrode 20 and the negative electrode active material layer 19 of the bipolar electrode 23 adjacent to the positive electrode termination electrode 20. Furthermore, a separator 25 is provided between the negative electrode active material layer 19 and the positive electrode termination electrode 20 of the adjacent bipolar electrodes 23.

As shown in FIGS. 1 and 2, both end faces in the lamination direction of the laminate 15 including the negative electrode termination electrode 17, the positive electrode termination electrode 20, the bipolar electrode 23, and the separator 25 are constituted by the current collector 18. As shown in FIG. 2, the outer peripheral portion of each current collector 18 when the laminate 15 is viewed along the lamination direction is a current collector foil 18-1 located on the outer peripheral side from the outer peripheral side end portions of the negative electrode active material layer 19 and the positive electrode active material layer 21.

The shape (planar shape) of the laminate 15 of the present embodiment when viewed along the lamination direction is a rectangle. That is, the shapes of the current collector 18, the negative electrode active material layer 19, the positive electrode active material layer 21, and the separator 25 when the laminate 15 is viewed along the lamination direction are rectangular. Further, as is apparent from FIG. 2, when the laminate 15 is viewed along the lamination direction, the outer peripheral side end portion of each negative electrode active material layer 19 is located on the outer peripheral side from the outer peripheral side end portion of each positive electrode active material layer 21. Furthermore, the shape of each negative electrode active material layer 19 when the laminate 15 is viewed along the lamination direction is the same, and the shape of each positive electrode active material layer 21 when the laminate 15 is viewed along the lamination direction is the same.

On the other hand, the shapes of the current collectors 18 when the laminate 15 is viewed along the lamination direction are different from each other. Here, the current collector 18 located at the center in the lamination direction is defined as the maximum protruding current collector 18C. That is, the sixth current collector 18 counted from the top and the sixth current collector counted from the bottom are the maximum protruding current collector 18C. As is apparent from FIG. 2, in the shape (outer shape) when viewed along the lamination direction, the maximum protruding current collector 18C is the largest among all the current collectors 18, and the shape of the current collectors 18 gradually decreases from the maximum protruding current collector 18C toward the upper side and the lower side. In other words, the outer peripheral side end portions 18PE of the respective current collectors 18 are gradually positioned on the inner peripheral side toward the upper side and the lower side from the maximum protruding current collector 18C. Further, the distance DF in the direction perpendicular to the lamination direction between the outer peripheral side end portions 18PE of the current collectors 18 adjacent to each other in the lamination direction when the laminate 15 is viewed along the lamination direction (in FIG. 2, only a part of the distance DF is shown) is larger than the dimension (thickness) in the lamination direction of the current collectors 18. For example, the distance DF in the front-rear direction between the front end face of the current collector 18 located uppermost and the front end face of the second current collector 18 from the top, and the distance DF in the front-rear direction between the front end face of the second current collector 18 from the bottom and the front end face of the third current collector 18 from the bottom are larger than the dimension in the lamination direction of the current collector 18.

The shapes of the separators 25 when viewed along the lamination direction of the laminate 15 are different from each other. That is, when viewed along the lamination direction of the separators 25, the shape is substantially the same as the shape of the current collector 18 facing the maximum protruding current collector 18C. Further, the outer peripheral side end portions of the separators 25 are located on the outer peripheral side from the outer peripheral side end portions of the negative electrode active material layer 19 and the positive electrode active material layer 21.

A resin member 30, which is an integrally molded product made of resin, is provided on the outer peripheral portion of the laminate 15. The resin member 30 is integrated with the outer peripheral portion of the laminate 15 in an airtight state and a liquid-tight state so as to cover the outer peripheral portion of the laminate 15. The shape of the resin member 30 when cut in a cross section perpendicular to the lamination direction is a rectangle having a rectangular opening formed in the central portion. The resin member 30 is made of an insulating resin material. The constituent material of the resin member 30 is, for example, polypropylene, polyethylene, polystyrene, ABS resin, acid-modified polypropylene, acid-modified polyethylene, or acrylonitrile styrene resin. For example, the resin member 30 may be integrally provided on the outer peripheral portion of the laminate 15 by insert molding performed while the laminate 15 is disposed inside a mold (not shown).

Although not shown, an electrolytic solution is provided inside the laminate 15, and the electrolytic solution is impregnated into the negative electrode termination electrode 17, the positive electrode termination electrode 20, and the bipolar electrode 23.

The battery 10 having the above-described configuration is fixed to an upper surface of a substantially horizontal plate member (not shown) that forms a part of the vehicle body constituent member of the above-described battery electric vehicle via a fixing unit.

As shown in FIGS. 1 and 2, the outer peripheral side end portions 18PE of the current collectors 18 of the negative electrode termination electrode 17, the positive electrode termination electrode 20, and the bipolar electrode 23 and the outer peripheral side end portions of the separators 25 are located inside the resin member 30. On the other hand, the outer peripheral side end portions of the respective negative electrode active material layers 19 and the respective positive electrode active material layers 21 are located on the inner peripheral side with respect to the inner peripheral surface of the central opening 30S of the resin member 30. Furthermore, the current collector 18 of the negative electrode termination electrode 17 is exposed through one opening end portion of the central opening 30S, and the current collector 18 of the positive electrode termination electrode 20 is exposed through the other opening end portion of the central opening 30S. Therefore, the electric power generated by the battery 10 can be supplied to various electric devices and electronic devices (not shown) provided in battery electric vehicle via a conductive member (not shown) connected to the current collector 18 of the negative electrode termination electrode 17 via one opening end of the central opening 30S and a conductive member (not shown) connected to the current collector 18 of the positive electrode termination electrode 20 via the other opening end of the central opening 30S.

### Action and Effect

Next, the operation and effects of the present embodiment will be described.

Here, it is assumed that vehicles (not shown) traveling forward in the rear area of battery electric vehicle collide with the rear end portion of battery electric vehicle. As shown in FIG. 3, battery electric vehicle includes a metallic member (conductive member) 40 that is a part of the vehicle body component and is located immediately after the battery 10. The front end face 41 of the member 40 is formed by a plane perpendicular to the front-rear direction at a time point prior to the collision of battery electric vehicle. Further, the lower end of the member 40 is positioned below the lower end of the battery 10, the upper end of the member 40 is positioned above the upper end of the battery 10, the left end of the member 40 is positioned to the left from the left end of the battery 10, and the right end of the member 40 is positioned to the right from the right end of the battery 10.

When such a collision occurs in the above-described battery electric vehicle, the member 40 may be relatively moved forward with respect to the battery 10 due to an impact generated in battery electric vehicle. Then, the member 40 may collide with the rear end portion (outer peripheral end portion) of the laminate 15 while breaking the rear portion 30R of the resin member 30 (see FIGS. 1 and 2). FIG. 3 shows the rear portion of the laminate 15 and the member 40 when such a condition occurs in battery electric vehicle while omitting the rear portion 30R (resin member 30).

As shown in FIG. 3, the front end face 41 of the member 40 contacts the rear end portion (outer peripheral end portion 18PE) of the maximum protruding current collector 18C of the bipolar electrode 23 located at the center in the lamination direction. Further, the front end face 41 contacts the rear end portion (outer peripheral side end portion) of the separator 25 facing the maximum protruding current collector 18C from above and the rear end portion (outer peripheral side end portion 18PE) of the current collector 18U which is the current collector 18 facing the separator 25 from above. Further, the front end face 41 contacts the rear end portion (outer peripheral side end portion) of the separator 25 facing the maximum protruding current collector 18C from below and the rear end portion (outer peripheral side end portion 18PE) of the current collector 18D which is the current collector 18 facing the separator 25 from below.

Incidentally, as described above, the outer peripheral side end portions 18PE of the respective current collectors 18 are gradually positioned on the inner peripheral side toward the upper side and the lower side from the maximum protruding current collector 18C. That is, the rear end portions of the respective current collectors 18 are positioned gradually forward from the maximum protruding current collector 18C toward the upper side and the lower side. Therefore, the front end face 41 hardly contacts the rear end portions of the respective current collectors 18 positioned above the current collector 18U and the rear end portions of the respective current collectors 18 positioned below the current collector 18D. That is, there is a high possibility that the maximum protruding current collector 18C and the two current collectors 18U, 18D located above and below the maximum protruding current collector 18C are externally short-circuited via the conductive member 40. Although the maximum protruding current collector 18C and the current collector 18U, 18D generate heat, it is unlikely that this heat will be a large amount of heat. That is, for example, when the member 40 is simultaneously contacted with the maximum protruding current collector 18C located at the center in the lamination direction and the current collector 18 located at the uppermost position or the lowermost position, the current collectors 18 generate an extremely large amount of heat. On the other hand, the amount of heat generated by the battery 10 when the maximum protruding current collector 18C and the two current collectors 18U, 18D positioned above and below the maximum protruding current collector 18C are externally short-circuited is smaller than the amount of heat generated when the maximum protruding current collector 18C positioned at the center and the current collector 18 positioned at the uppermost position or the lowermost position are externally short-circuited. That is, in the battery 10 of the present embodiment, an external short circuit with large heat is unlikely to occur between the current collector foils 18-1 of the plurality of current collectors 18.

Furthermore, the distance DF between the outer peripheral end portions 18PE of the current collectors 18 adjacent to each other in the lamination direction when the laminate 15 is viewed along the lamination direction is larger than the dimension (thickness) of the current collector 18 in the lamination direction. That is, when the laminate 15 is viewed along the lamination direction, the distance between the outer peripheral end portions 18PE of the adjacent current collectors 18 is large. Therefore, there is less possibility that the member 40 (front end face 41) simultaneously contacts the outer peripheral side end portion 18PE of the current collector 18 of a large number (for example, four or more) as compared with the case where the distance DF between the outer peripheral side end portions 18PE of the adjacent current collectors 18 is equal to or smaller than the dimension (thickness) of the current collector 18 in the lamination direction.

Further, since the battery 10 includes the bipolar electrode 23, the battery 10 can generate a large amount of electric power as compared with a case where the bipolar electrode 23 is not provided. That is, since the bipolar electrodes 23 can generate a large current (for example, a 5A or more), the degree of increase in temperature of the battery 10 when an external short circuit occurs is higher than that when an external short circuit occurs in a battery that does not include the bipolar electrode. Therefore, compared with the case where the present disclosure is applied to a battery that does not include the bipolar electrode 23, the case where the present disclosure is applied to the battery 10 can obtain greater usefulness.

Although the battery 10 according to the embodiment has been described above, it is possible to appropriately change the design without departing from the gist of the present disclosure.

For example, the outer peripheral end portions 18PE of the two current collectors 18 adjacent to each other in the lamination direction may overlap each other in the up-down direction when the laminate 15 is viewed in the lamination direction.

The outer peripheral side end portion 18PE of the current collector 18 located at the central portion in the lamination direction may be located at the outermost peripheral side among all the current collectors 18. Here, the “central portion” refers to a region between the current collector 18 that is N/3 from the uppermost current collector 18 and the current collector 18 that is N/3 from the lowermost current collector 18 when the total number of the current collectors 18 is N. For example, when the battery 10 is provided with 11 current collectors 18 as in the present embodiment, N/3=3.666. In this case, the outer peripheral side end portion 18PE of at least one current collector 18 located in any of the areas between the fourth current collector 18 from the top and the fourth current collector 18 from the bottom is located on the outermost peripheral side. Further, for example, when the battery 10 includes 18 current collectors 18, the outer peripheral side end portion 18PE of the current collector 18 located in any of the areas between the sixth current collector 18 from the top and the sixth current collector 18 from the bottom is located on the outermost peripheral side. In this modification as well, there is little possibility that the member 40 simultaneously contacts the current collector 18 having the outermost end portion 18PE and the current collector 18 located at the uppermost position or the lowermost position.

If the outer peripheral side end portion 18PE of at least one current collector 18 located at the center portion in the lamination direction is located on the outer peripheral side from the outer peripheral side end portion 18PE of the current collector 18 located at the end portion in the lamination direction, the outer peripheral side end portion 18PE of the other current collector 18 may be located on the inner peripheral side from the outer peripheral side end portion 18PE of the current collector 18 located at the end portion in the lamination direction.

The number of electrodes provided in the battery 10 may be any number as long as the number of electrodes is plural.

All of the electrodes provided in the battery 10 may be constituted by electrodes that are not bipolar electrodes.

The battery 10 may be configured such that the laminate is covered with a container formed of a laminate film.

The battery 10 may be provided in a device other than battery electric vehicle.

What is claimed is:

1. A battery comprising a laminate, the laminate being configured by laminating, in a predetermined lamination direction,
current collectors,
a plurality of electrodes each including at least one of a positive electrode active material layer and a negative electrode active material layer formed on each of the current collectors, and
a plurality of separators located between the positive electrode active material layers and the negative electrode active material layers, wherein:
the current collectors each have a portion made of a current collector foil where the positive electrode active material layer and the negative electrode active material layer are not formed; and
when the laminate is viewed in the lamination direction, outer peripheral end portions of the current collector foils that are located at a central portion in the lamination direction are located on outer peripheral sides of the outer peripheral end portions of the current collector foils that are located at end portions in the lamination direction.

2. The battery according to claim 1, wherein the electrodes other than the electrodes located at the end portions in the lamination direction are bipolar electrodes each including the current collector, the positive electrode active material layer formed on one surface of the current collector, and the negative electrode active material layer formed on another surface of the current collector.

3. The battery according to claim 1, wherein the outer peripheral end portions of the current collector foil that is located at a center in the lamination direction is located on the outer peripheral sides of the outer peripheral end portions of the current collector foils that are located at the end portions in the lamination direction.

4. The battery according to claim 1, wherein when the laminate is viewed in the lamination direction, a distance between the outer peripheral end portions of the current collector foils adjacent to each other in the lamination direction is larger than a size of the current collectors in the lamination direction.

5. The battery according to claim 1, wherein when the current collector, having the outer peripheral end portions that are located on outermost peripheral sides when the laminate is viewed in the lamination direction, is defined as a maximum protruding current collector, the current collectors, other than the maximum protruding current collector, have the outer peripheral end portions that are located on inner peripheral sides of the outer peripheral end portions of the current collector foils on the current collectors that are located closer to the maximum protruding current collector.
